(19) United States
(12) Patent Application Publication
(10) Pub. No.: US 2012/0012093 A1
(43) Pub. Date: Jan. 19, 2012

(54) GRAPHIC COOKTOP COVER

(75) Inventors: NIRMAL KUMAR MISHRA, PUNE (IN); PRASHANT RUPEREE, PUNE (IN)

(73) Assignee: WHIRLPOOL CORPORATION, BENTON HARBOR, MI (US)

(21) Appl. No.: 12/835,850

(22) Filed: Jul. 14, 2010

(51) Int. Cl. F24C 15/10; B32B 3/10

(52) U.S. Cl. 126/211; 428/131

(57) ABSTRACT

A cooking appliance including a glass cooktop having a plurality of spaced heating elements is provided with a cover in the form of a sheet which clings to the upper surface of the cooktop, about the heating elements, to protect the cooktop from spills, scratches and the like during use, while also preferably providing a decorative, graphic appearance.

### BACKGROUND OF THE INVENTION

1. Field of the Invention

The present invention pertains to the art of cooking and, more particularly, to a readily removable, heat resistant, graphic cover for a glass cooktop cooking appliance.

2. Description of the Related Art

In years past, domestic kitchens were only configured to be functional, representing a place to simply store and prepare food. However, kitchens are now often a focal point in overall home design. In fact, the configuration and amenities offered by a kitchen is rated one of the highest selling points for homes. Therefore, instead of merely being functional, kitchens are typically designed based on the architecture and scheme of the overall home. For instance, a contemporary home may have multiple appliances which are directly built into and take the general appearance of adjacent cabinetry in order to provide a sleek, uniform overall kitchen configuration. To this end, it is known to provide textured wooden panels to the face portions of appliances, such as refrigerators, dishwashers, and the like, which enable the appliances to exactly match the cabinetry. At the very least, consumers can now commonly choose between various, readily available colors, including white, black and almond, for their kitchen appliances.

In addition to the above, it has been proposed in the art to provide a domestic appliance with a structured decorative panel as demonstrated by the decorative magnetic sheet set forth in U.S. Pat. No. 6,840,773. However, such decorative panels are not practical in a heated environment, such as a cooktop. In fact, although there exists various decorative panels or sheets for refrigerators and dishwashers typically found in the kitchens of domestic residences, cooking appliances are basically left to their originally intended configurations and designs. With that said, it has been proposed to provide removably mounted plate-like structures for a cooktop that collects food sputterings or spills, as taught by PCT patent document WO 02/05596. However, such plate-like structures are a bulky addition to a cooktop surface and not aesthetically appealing.

With the ability to select between various designs and configurations given the number of competitors in the market, choosing an appropriately designed cooktop is really not a problem. However, over time, the surfaces of cooktops can become scratched or marred, whether through cooking accidents or upon being cleaned. Therefore, over time, the aesthetic appearance of a cooktop can deteriorate. This problem can be particularly acute in connection with glass cooktops. With this in mind, it would be beneficial to provide a graphic cover for a cooktop, particularly a glass cooktop, with the cover being readily applied and removed, providing a decorative appearance and exhibiting a functional benefit of protecting the cooktop from becoming scratched, marred, soiled or the like.

### SUMMARY OF THE INVENTION

The present invention is directed to a cooking appliance including a glass cooktop having a plurality of spaced heating elements and, more particularly, a protective cover which clings to the upper surface of the cooktop, about the heating elements, to protect the cooktop from spills, scratches and the like. The cover preferably has a decorative, graphic appearance which can match or contrast with surrounding kitchen structure, such as a countertop. The cover is formed from a heat resistant material, thus enabling the cover to remain in place when the cooktop is used for cooking operations.

Additional objects, features and advantages of the present invention will become more readily apparent from the following detailed description of preferred embodiments when taken in conjunction with the drawings wherein like reference numerals refer to corresponding parts in the several views.

### BRIEF DESCRIPTION OF THE DRAWINGS

FIG. 1 is a perspective view of a kitchen region including cabinetry, a countertop and a cooktop provided with a cover, having a certain graphic design, in accordance with the invention; and

FIG. 2 is a top view of the cooktop cover of the invention shown with a different graphic design.

### DETAILED DESCRIPTION OF PREFERRED EMBODIMENTS

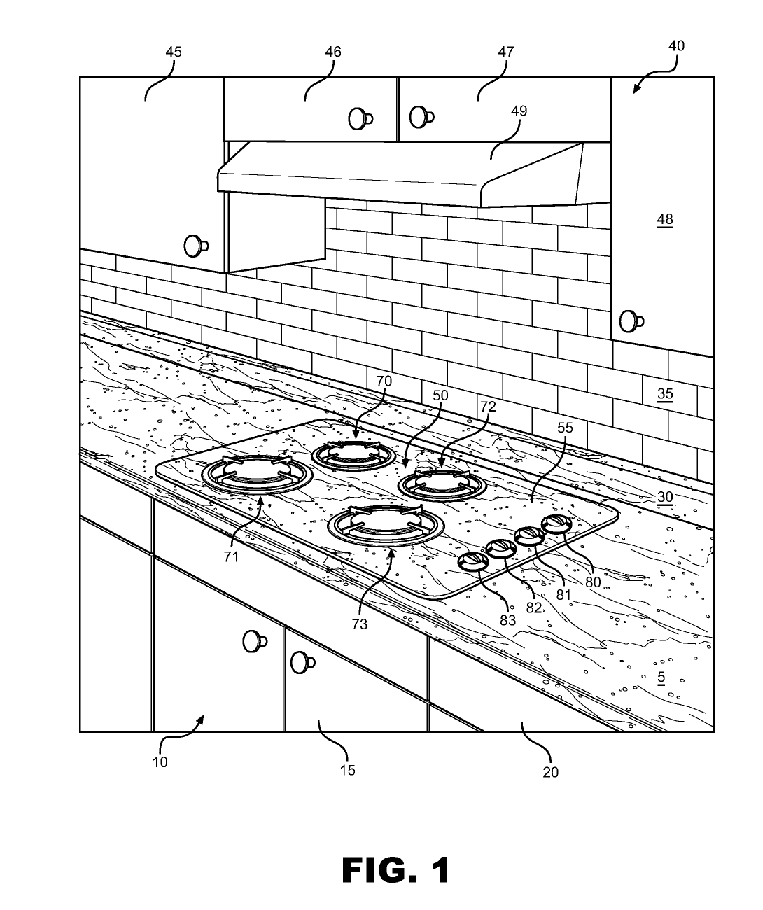

FIG. 1 is intended to generically illustrate a domestic kitchen in which the invention is employed. To this end, there is illustrated a countertop 5 mounted upon lower cabinetry 10, including cabinet doors, one of which is indicated at 15, and drawers, one of which is indicated at 20. Countertop 5 has an associated backsplash 30 which is positioned against a wall 35. Mounted to wall 35 is cabinetry 40, including a series of cabinet doors 45-48. In the embodiment shown, between cabinet doors 46 and 47 is positioned a vent hood 49. In particular, it is important to recognize the inclusion of a cooking appliance in the form of a cooktop 50 mounted to countertop 5 and, more importantly, the existence of a cooktop cover 55 provided atop cooktop 50 in accordance with the present invention as will be detailed fully below.

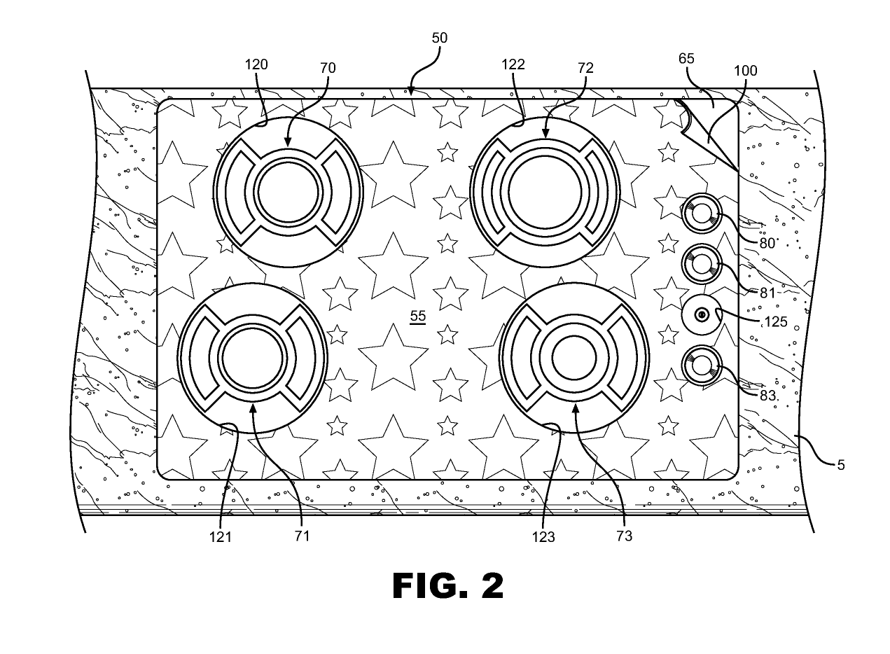

In general, cooktop 50 includes a substantially planar top surface 65 (see FIG. 2). In addition, cooktop 50 is provided with a series of spaced heating elements 70-73 which are designed to be individually regulated by respective control elements such as rotatable knobs 80-83. At this point, it should be understood that heating elements 70-73 can take various forms such as, for instance, gas burner elements having surface burners and associated grates mounted to cooktop 50 as shown in FIG. 1 but not separately labeled, or electric heating elements as represented in FIG. 2. Actually, the structure and operation of cooktop 50 is known in the art such that it will not be detailed further here. Instead, it is just important to note that cooktop 50 constitutes a glass cooktop which, in accordance with the invention, includes glass, glass/ceramic and the like formed cooktops, whether built into a countertop, provided on a slide-in or free-standing range, establishing a stand alone cooktop or the like. The invention is also equally applicable with electric, gas, gas-under-glass and the like heating arrangements.

Regardless of the particular type of heating system, when provided for sale, top surface 65 of cooktop 50 will be smooth and have a predetermined design. In accordance with the present invention, protective cooktop cover or skin 55 constitutes a sheet, such as a film or thin mat, and is provided for use in covering at least a substantial portion of top surface 65. Cover 55 can be provided with any number of different graphic designs, including a grain appearance which directly matches a pattern of countertop 5 as shown in FIG. 1 or a different graphic appearance from the countertop as shown in FIG. 2. In any case, cover 55 is comprised of a material that can be readily applied to and removed from top surface 65, while also being able to withstand the heat, due to the proximity to heating elements 70-73, without becoming warped or damaged. In accordance with a preferred embodiment, cover 55 is comprised of a heat resistant material which can also statically adhere to the glass of cooktop 50, such as silicon, and can vary greatly in thickness, such as from a few mils to about a couple millimeters. In another embodiment, a peelable, reusable adhesive can be employed. With either construction, cover 55 can be readily applied to top surface 65 and will remain in tight adherence during use. On the other hand, cover 55 can be easily peeled (see upturned edge 100 in FIG. 2) from upon top surface 65 for cleaning or replacement.

Cooktop cover 55 is specifically designed to have a custom fit appearance. To this end, cover 55 can be manufactured for use with a particular cooktop 50 or can be sold as a sheet which can be cut to size and sold as a retrofit for an existing cooktop 50. In either case, cover 55 is provided with various spaced openings 120-123 (see FIG. 2) for heating elements 70-73 and, in connection with the embodiments shown, with additional spaced openings, such as that indicated at 125, for control knobs 80-83. The openings 125 are preferably smaller than the size of knobs 80-83, while the openings 120-123 are preferably larger that the size of heating elements 70-73 to maintain a spacing which enables large pots and pans to be used with cooktop 50 without resting upon cover 55. In this manner, cover 55 can remain on top surface 65 during use of cooktop 50 by the activation of one or more of heating elements 70-73. If cooktop 50 has an associated electronic control panel (not shown) cover 55 would be specifically configured to fit around the periphery of the control panel.

Based on the above, it should be readily apparent that the present invention allows a consumer to cheaply and quickly customize their kitchen cooktop without the need for replacing the cooktop. Additionally, the cooktop cover of the present invention protects the consumer's cooktop from spills and scratches, while being easily removable for cleaning or replacement. That is, given the material employed and the use in connection with a glass cooktop, the cover will cling to the surface of the cooktop, while being readily removable. The cover is specifically cut-out around heating element regions and is formed from a heat resistant material such that the cover is designed to remain on the cooktop during repeated uses of the cooking appliance and can either be cleaned in place or peeled from the top surface of the cooktop, cleaned and then re-applied. After the cover itself is damaged or overly soiled, or if the user simply desires a different graphic design for the cooktop, the cover can be discarded and replaced. In any case, although described with reference to preferred embodiments of the invention, it should be readily understood that various changes and/or modifications can be made to the invention without departing from the spirit thereof. For instance, although depicted for use with a four-element cooktop, the cooktop cover of the present invention is not limited to any particular configuration. In general, the invention is only intended to be limited by the scope of the following claims.

What is claimed is:

1. A cooking appliance comprising:
a glass cooktop having a smooth top surface and a plurality of spaced heating elements; and
a protective graphic cover constituted by a sheet including a plurality of spaced openings, said cover being positioned upon and adhering to the top surface of the glass cooktop with the plurality of spaced openings extending about the plurality of spaced heating elements, wherein the cover removably extends across a portion of the top surface to protect the top surface from spills and scratches during use of the cooktop, while altering an appearance of the top surface.

2. The cooking appliance according to claim 1, wherein the cover is formed from a material which statically clings to glass.

3. The cooking appliance according to claim 1, wherein the cover is comprised of silicon.

4. The cooking appliance according to claim 1, wherein the cover is formed of a heat resistant material.

5. The cooking appliance according to claim 4, wherein material of the cover statically clings to glass.

6. The cooking appliance according to claim 5, wherein material constitutes silicon.

7. The cooking appliance according to claim 1, wherein the cooktop further includes a plurality of control knobs and the cover further includes a plurality of openings for the control knobs.

8. The cooking appliance according to claim 1, wherein the cooktop is mounted within a countertop having a decorative pattern, said cover including graphics corresponding to the decorative pattern of the countertop.

9. The cooking appliance according to claim 1, wherein the cooktop is mounted within a countertop having a decorative pattern, said cover including graphics distinct from the decorative pattern of the countertop.

10. A protective graphic cover for a glass cooktop having a plurality of spaced heating elements comprising:
a sheet; and
a plurality of spaced openings formed in said sheet, wherein said cover is adapted to positioned upon and adhere to a top surface of the glass cooktop with the plurality of spaced openings extending about the plurality of spaced heating elements such that the cover removably extends across a portion of the top surface of the glass cooktop to protect the top surface from spills and scratches during use of the cooktop, while altering an appearance of the top surface.

11. The protective graphic cover according to claim 10, wherein the sheet is formed from a material which statically clings to glass.

12. The protective graphic cover according to claim 10, wherein the cover is comprised of silicon.

13. The protective graphic cover according to claim 10, wherein the sheet is formed from a material which is heat resistant.

14. The protective graphic cover according to claim 13, wherein the material of the sheet statically clings to glass.

15. The protective graphic cover according to claim 14, wherein the material constitutes silicon.
